(19) United States
(12) Patent Application Publication
(10) Pub. No.: US 2011/0120428 A1
(43) Pub. Date: May 26, 2011

(54) METHOD FOR CONTROLLING THE LEVEL OF OXYGEN IN THE INTAKE MANIFOLD OF AN INTERNAL COMBUSTION ENGINE EQUIPPED WITH A LOW PRESSURE EGR SYSTEM

(75) Inventors: Paolo PASERO, Torino (IT); Francesco CASTORINA, Torino (IT)

(73) Assignee: GM GLOBAL TECHNOLOGY OPERATIONS, INC., Detroit, MI (US)

(21) Appl. No.: 12/946,755

(22) Filed: Nov. 15, 2010

(30) Foreign Application Priority Data
Nov. 16, 2009 (GB) 0920015.5

(51) Int. Cl. F02B 33/00; F02M 25/07

(52) U.S. Cl. 123/564; 123/568.12

(57) ABSTRACT

A method is provided for controlling the level of oxygen concentration in the intake manifold of an internal combustion engine system. The engine having an intake manifold and an exhaust manifold and corresponding intake and exhaust lines, the intake line having a leading point for mixing of fresh air, first and second EGR routes, a charge air cooler located in the intake line upstream the intake manifold and downstream the second EGR route, a turbocharger having a compressor located in the intake line and a turbine located in the exhaust line, the exhaust line having a diesel oxidation catalyst and an antiparticulate filter. The system has a regulator for regulating the flow rate of exhaust gas. The regulator including, but not limited to a low pressure EGR valve associated to the second EGR route. The method including, but not limited to at least a phase of determination of the oxygen concentration set-point at any point in the portion of the intake line between said leading point up to the intake manifold and a phase of maintaining the desired oxygen concentration set-point in any point of said portion.

### CROSS-REFERENCE TO RELATED APPLICATION

This application claims priority to British Patent Application No. 0920015.5, filed Nov. 16, 2009, which is incorporated herein by reference in its entirety.

### TECHNICAL FIELD

The technical field relates to a method for controlling the level of oxygen concentration in the intake manifold of an internal combustion engine, in particular a turbocharged Diesel engine system equipped with a low pressure EGR system.

### BACKGROUND

A turbocharged Diesel engine system generally comprises a Diesel engine having an intake manifold and an exhaust manifold, an intake line for conveying fresh air from the environment in the intake manifold, an exhaust line for conveying the exhaust gas from the exhaust manifold to the environment, and a turbocharger which comprises a compressor located in the intake line for compressing the air stream flowing therein, and a turbine located in the exhaust line for driving said compressor.

The turbocharged Diesel engine system further comprises an intercooler, also called a charge air cooler, located in the intake line downstream the compressor, for cooling the air stream before it reaches the intake manifold, and a diesel oxidation catalyst (DOC) located in the exhaust line downstream the turbine, for degrading residual hydrocarbons and carbon oxides contained in the exhaust gas. The turbocharged Diesel engine systems can also be equipped with a diesel particulate filter (DPF) located in the exhaust line downstream the DOC, for capturing and removing diesel particulate matter (soot) from the exhaust gas.

In order to reduce the polluting emission, most turbocharged Diesel engine system actually comprises an exhaust gas recirculation (EGR) system, for selectively routing back exhaust gas from the exhaust manifold into the intake manifold. The exhaust gas mixed with the fresh induction air is aspired into the engine cylinders, in order to reduce the production of oxides of nitrogen (NOₓ) during the combustion process.

Conventional EGR systems comprise an high pressure EGR conduit for fluidly connecting the exhaust manifold with the intake manifold, an EGR cooler for cooling the exhaust gas before mixing it with the induction air, valve means for regulating the flow rate of exhaust gas through the EGR conduit, and a microprocessor based controller (ECU) for determining the required amount of exhaust gas and for controlling said valve means accordingly.

In order to further reduce the NOₓ emission, improved EGR systems comprise also an additional low pressure EGR conduit, which fluidly connects the exhaust line downstream the DPF with the intake line upstream the compressor, an additional EGR cooler located in the additional EGR conduit, and additional valve means for regulating the flow rate of exhaust gas through the additional EGR conduit. In these improved systems, while the conventional EGR conduit defines a short route for the exhaust gas recirculation, the additional EGR conduit defines a long route for the exhaust gas recirculation, which comprises also a relevant portion of the exhaust line and a relevant portion of the intake line. While low pressure EGR conduit systems have several benefits, as explained above, they also raise the complexity of the engine structure and the burden of controlling the various parameters of the combustion.

In view of the foregoing, at least a first object is therefore to perform an optimal control strategy of Nitrogen Oxides (NOₓ) emissions in a diesel engine provided with a low pressure EGR system. At least another object is to provide such optimal strategy without using complex devices and taking advantage from the computational capabilities of the Electronic Control Unit (ECU) of the vehicle. At least another object is to meet these goals by means of a simple, rational and inexpensive solution. In addition, other objects, desirable features and characteristics will become apparent from the subsequent summary and detailed description, and the appended claims, taken in conjunction with the accompanying drawings and this background.

### SUMMARY

A method, an engine, a computer program and computer program product, and an electromagnetic signal are provided in according to embodiments of the invention. The method is provided for controlling the level of oxygen concentration in the intake manifold of an internal combustion engine system. The engine having an intake manifold and an exhaust manifold and corresponding intake and exhaust lines, the intake line having a leading point for mixing of fresh air, first and second EGR routes, a charge air cooler located in the intake line upstream the intake manifold and downstream the second EGR route, a turbocharger having a compressor located in the intake line and a turbine located in the exhaust line, the exhaust line having a diesel oxidation catalyst (DOC) and an antiparticulate filter (DPF), the system having a regulator for regulating the flow rate of exhaust gas. The regulator comprising a low pressure EGR valve associated to the second EGR route. The method comprises at least a phase of determination of the oxygen concentration set-point at any point in the portion of the intake line comprised between the leading point up to the intake manifold and a phase of maintaining the desired oxygen concentration set-point in any point of the portion.

The method can be realized in the form of a computer program comprising a program-code to carry out all the steps of the method of the invention and in the form of a computer program product comprising means for executing the computer program. The computer program product comprises, according to a preferred embodiment of the invention, a control apparatus for an IC engine, for example the ECU of the engine, in which the program is stored so that the control apparatus defines the invention in the same way as the method. In this case, when the control apparatus execute the computer program all the steps of the method are carried out.

The method can be also realized in the form of an electromagnetic signal, said signal being modulated to carry a sequence of data bits which represent a computer program to carry out all steps of the method. An internal combustion engine is also provided that is specially arranged for carrying out the method.

### BRIEF DESCRIPTION OF THE DRAWINGS

The present invention will hereinafter be described in conjunction with the following drawing

FIG. 1, which is a schematic illustration of a turbocharged Diesel engine system allowing the method according an embodiment of the invention.

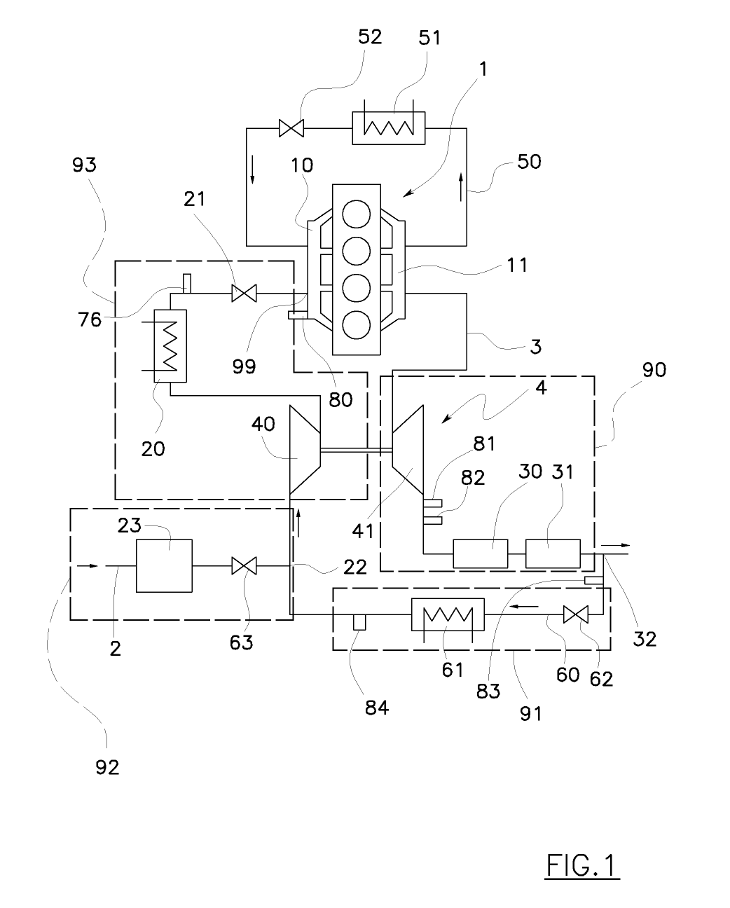

### DETAILED DESCRIPTION

The following detailed description is merely exemplary in nature and is not intended to limit application and uses. Furthermore, there is no intention to be bound by any theory presented in the preceding background or summary or the following detailed description. In addition, the embodiments hereinafter disclosed with reference to a turbocharged Diesel engine system. However, the embodiments are applicable to different Diesel engine systems and even to spark-ignition engine systems.

The turbocharged Diesel engine system comprises a Diesel engine 1 having an intake manifold 10 and an exhaust manifold 11, an intake line 2 for conveying fresh air from the environment in the intake manifold 10, an exhaust line 3 for conveying the exhaust gas from the exhaust manifold 11 to the environment, and a turbocharger 4 which comprises a compressor 40 located in the intake line 2 for compressing the air stream flowing therein, and a turbine 41 located in the exhaust line 3 for driving said compressor 40. A temperature sensor 80 is provided for determining the temperature within the intake manifold 10. The turbocharged Diesel engine system further comprises an intercooler (or charge air cooler) 20 located in the intake line 2 downstream the compressor 40 of turbocharger 4, for cooling the air stream before it reaches the intake manifold 10, and a valve 21 located in the intake line between the intercooler 20 and the intake manifold 10. The turbocharged Diesel engine system further comprises a diesel oxidation catalyst (DOC) 30 located in the exhaust line 3 downstream the turbine 41 of turbocharger 4, for degrading residual hydrocarbons and carbon oxides contained in the exhaust gas, and a diesel particulate filter (DPF) 31 located in the exhaust line 3 downstream the DOC 30, for capturing and removing diesel particulate matter (soot) from the exhaust gas.

In order to reduce the pollutant emission, the turbocharged Diesel engine system comprises an exhaust gas recirculation (EGR) system, for selectively routing back exhaust gas from the exhaust manifold into the intake manifold. The EGR system comprise a first EGR conduit 50 for directly fluidly connecting the exhaust manifold 11 with the intake manifold 12, a first EGR cooler 51 for cooling the exhaust gas, and a first electrically controlled valve 52 for determining the flow rate of exhaust gas through the first EGR conduit 51. The first EGR conduit 51 defines a short route for the exhaust gas recirculation cooler, so that the exhaust gas routed back by this first EGR conduit 51 is quite hot. The EGR system further comprise a second EGR conduit 60, which fluidly connects a branching point 32 of the exhaust line 3 downstream the DPF 32 with a leading point 22 of the intake line 2 upstream the compressor 40 of turbocharger 4, and a second EGR cooler 61 located in the additional or second EGR conduit 60.

The flow rate of exhaust gas through the second EGR conduit 60 is determined by an electrically controlled valve 62, wherein the valve 62 is located in the second EGR conduit 60 upstream the second EGR cooler 61. A valve 63 is located in the intake line 2 downstream an air filter 23 and upstream the leading point 22. The second EGR conduit 60 defines a long route for the exhaust gas recirculation, which comprises also the portion of the exhaust line 3 comprised between the exhaust manifold 11 and the branching point 32, and the portion of the intake line 2 comprised between the leading point 22 to the intake manifold 10. Flowing along the long route, the exhaust gas is obliged to pass through the turbine 41 of turbocharger 4, the DOC 30, the DPF 31, the second EGR cooler 61, the compressor 40 of turbocharger 4 and the intercooler 20, so that it become considerably colder than the exhaust gas which flows through the first EGR conduit 50, to thereby reaching the intake manifold at a lower temperature.

The turbocharged Diesel engine system is operated by a microprocessor (ECU) based control circuit, which is provided for generating and applying control signals to the valves 52, 62 and 63, to thereby adjusting the flow rate of exhaust has through the first EGR conduit 50 and the second EGR conduit 60.

A particular emphasis is given to valve 62 as it will be apparent in the following description. In fact, a method to control the EGR flow coming from the low pressure loop is provided. The method comprising an estimate the oxygen concentration at the intercooler 20 outlet and, on the basis of such estimation, a phase of maintaining the desired oxygen concentration set-point at the charge air cooler 21 outlet by means of regulation of said low pressure EGR valve. Specifically the method can be divided in two parts: a first part will be described with reference to charge an air cooler outlet oxygen estimation model. The aim of this model is to estimate the oxygen concentration within the low pressure EGR circuit portion that comprises the mixing point 22 and the intake manifold inlet 99 based on the information coming from sensors and other models. All these information are fed to the Electronic Control Unit (ECU) of the vehicle and calculations representative of the model are provided by the ECU. The second part of the method is the construction and employment of a low pressure EGR control algorithm. The goal of the control algorithm is to regulate the low pressure EGR valve to achieve the desired oxygen concentration within the low pressure EGR circuit.

Describing now the low pressure EGR oxygen model we note that it can be dived in four subsystems: Exhaust line delay model 90; Low pressure EGR flow model 91; Low pressure EGR mixing model 92; and Intake line delay model 93. The goal of the exhaust line delay model 90 is to model the delay of the exhaust mass air fraction between the exhaust manifold and the DPF outlet where the low pressure EGR is recirculated. The model may be thought as a low pass filter having a time constant t and receiving an exhaust flow from the exhaust line and outputting an exhaust flow from the DPF filter.

The low pass filter time constant t can be calculated in two ways. A first option is given by a map-based approach, whereby the time constant is function of the engine operating point.

τ=f(engine speed, infected fuel)

A second option is given by a model-based approach. In this case, the time constant t is modelled considering the volume of the exhaust line (mainly composed by the DPF) and the exhaust mass flow passing through that volume.

$$τ - \frac{{m}_{DPF}}{{m}_{DPF}}$$

Where: \dot{m}_{DPF} is the exhaust mass flow through the DPF, m_{DPF} is the exhaust mass in the DPF volume that can be calculated considering also the particulate trapped inside the DPF, where:

$${m}_{DPF} = \frac{{p}_{DPF} ( {V}_{DPF} - {m}_{SOOT} \cdot {ρ}_{SOOT} )}{{T}_{DPF} \cdot {R}_{exk}}$$

where p_{DPF} is the pressure upstream the DPF measured by a dedicated sensor 81, V_{DPF} is the DPF volume, m_{SOOT} is the soot mass trapped inside the DPF calculated from a suitable existing DPF statistical model, ρ_{SOOT} is the soot density, T_{DPF} is the temperature upstream the DPF measured by a dedicated, sensor 82, and Rₑₓₕ is the gas constant (287 J/KgK).

Describing now the low pressure EGR flow model 91 we note that is has the goal to estimate the EGR flow coming from the low pressure loop by means of the following equation:

$${β}_{critic} = {( \frac{2}{k + 1} )}^{\frac{k}{k - 1}}$$

If the recirculated exhaust flow isn't in sonic condition (β≧βcritic) where the low pressure EGR flow can be calculated according to the following equations:

$${\dot{m}}_{DPF} = \frac{{p}_{DPF , out}}{\sqrt{{R}_{exk} \cdot {T}_{DPF}}} \cdot {A}_{eff} \cdot f ( β )$$

### With

$$β = \frac{\text{?}}{\text{?}}$$

$$f ( β ) = \sqrt{( {β}^{\frac{2}{k}} - {β}^{\frac{k + 1}{k}} ) \cdot ( \frac{2 k}{k - 1} )} If β \leq {β}_{THR}$$

$$f ( β ) = \sqrt{( {β}^{\frac{2}{k}} - {β}^{\frac{k + 1}{k}} ) \cdot ( \frac{2 k}{k - 1} )} \cdot ( \frac{1 - β}{1 - {β}_{THR}} ) If β > {β}_{THR}$$

$$\text{?} \text{indicates text missing or illegible when filed}$$

If the recirculated exhaust flow is in sonic conditions (β<β_{critic}):

$$f ( β ) = \sqrt{k \cdot {( \frac{2}{k \vert 1} )}^{\frac{k + 1}{k - 1}}}$$

where: p_{DPF,out} is the pressure downstream DPF (where the low pressure EGR gases are recirculated) measured by a dedicated sensor 83, Rₑₓₕ is the gas constant (287 J/KgK), T_{LPE} is the temperature of the EGR measured by a dedicated sensor 84 placed downstream the low pressure EGR cooler, A_{eff} is a calibration parameter in function of the actual low pressure EGR valve position, namely valve 62, [symbol] is a calibration parameter k=1.4

The last input of this model is the pressure upstream the compressor that is estimated with the following model:

$${p}_{company} = {p}_{amb} - K \cdot \frac{{T}_{air}}{{p}_{amb}} \cdot {\dot{m}}_{air}^{2}$$

Where p_{amb} is the ambient pressure measured by a sensor integrated in the ECU, Tₐᵢᵣ is the temperature of the fresh air measured by a sensor integrated in the MAF sensor, and \dot{m}ₐᵢᵣ is the mass air flow measured by the MAF sensor.

The low pressure EGR mixing model 92 provides the total compressor flow, namely the sum of fresh air and EGR flow recirculated from the low pressure loop and the compressor inlet air fraction that is then used to calculate the oxygen concentration.

\dot{m}_{comp}=\dot{m}ₐᵢᵣ+\dot{m}_{LPE}

where \dot{m}ₐᵢᵣ is the mass air flow measured by the MAF sensor, \dot{m}_{LPE} is the low pressure EGR flow estimated in the low pressure EGR flow model 91, and

$${f}_{air , comp , up} = \frac{{\dot{m}}_{air} + {f}_{air , DPF} \cdot {\dot{m}}_{DPF}}{{\dot{m}}_{comp}}$$

where \dot{m}ₐᵢᵣ is the mass air flow measured by the MAF sensor, \dot{m}_{LPE} is the low pressure EGR flow estimated in the low pressure EGR flow model 91, f_{air,DPF} is the DPF outlet air fraction coming from the exhaust line delay model 90, and \dot{m}_{comp} is the compressor mass flow

The upstream compressor air fraction is then converted into an oxygen concentration using the assumption that intake and exhaust mixtures are composed only of Oxygen and Nitrogen. This concentration is then used to close the loop on the desired oxygen set-point and, thus, regulate the position of the low pressure EGR valve 62. The goal of the intake line delay model 93 is to model the delay both of the upstream compressor mass air fraction and the compressor flow between the compressor inlet and the charge air cooler outlet. The aim of the air fraction delay model subsystem is to model the delay of the compressor mass air fraction before flowing into the intake manifold and then be consumed by the intake manifold observer.

As for the upstream compressor air fraction, the charge air cooler air fraction is then converted into an oxygen concentration using the assumption that intake and exhaust mixtures are composed only of Oxygen and Nitrogen. The oxygen estimation can be used to close the loop on the desired oxygen set-point and, thus, regulate the low pressure EGR valve 62 position. The model may be thought as a low pass filter having a time constant t and receiving a mass flow from the compressor and outputting a mass flow from the air charge cooler.

The low pass filter time constant t can be calculated in two ways:

A first option is to use a map-based approach whereby the time constant t is function of the engine operating point.

τ=f(engine speed, infected fuel)

A second option is to use a model-based approach. In this second case the time constant t is modelled considering the volume of the intake line, mainly composed by the charge air cooler and intake pipe, and the mass flow passing through that volume that is the compressor flow estimated in the low pressure EGR mixing model.

$$τ = \frac{{m}_{ic}}{{\dot{m}}_{comp}}$$

where \dot{m}_{comp} is the compressor mass flow coming from the low pressure EGR mixing model, m_{DPF} m_{ic} is the mass in the charge air cooler and intake line volume, and

$${m}_{ic} = \frac{{p}_{ic} {V}_{ic}}{{T}_{ic} \cdot {R}_{mix}}$$

where p_{ic} is the pressure downstream the charge air cooler that can be considered equal to the one measured in the intake manifold, V_{ic} is the charge air cooler and intake line volume, T_{ic} is the temperature downstream the charge air cooler measured by a dedicated sensor 76, Rₘᵢₓ is the gas constant of the mixing between fresh air and low pressure EGR flow (287 J/KgK)

The aim of the intake line mass flow delay model subsystem is to model the delay of the compressor mass flow before flowing into the intake manifold and then consumed by the intake manifold observer and can also be thought as a low pass filter. The low pass filter time constant t can be calculated in two ways. A first option is to use a map-based approach whereby the time constant is function of the engine operating point:

τ=f(engine speed, infected fuel)

A second option is to use a model-based approach whereby the time constant t is modelled considering the volume of the intake line (mainly composed by the intercooler 20 and intake pipe) and the volumetric flow passing through that volume, which is the compressor flow converted.

$$τ = \frac{{V}_{ic}}{{V}_{comp}}$$

Where V_{ic} is the volume of the charge air cooler and the intake line, \dot{V}_{comp} is the compressor volumetric flow calculated as:

$${\dot{V}}_{ic} = \frac{{\dot{m}}_{comp}}{{ρ}_{comp}}$$

Where \dot{m}_{comp} is the compressor mass flow calculated in the low pressure EGR mixing model 92, ρ_{comp} is the charge density upstream the compressor calculated as:

$${ρ}_{comp} = \frac{{p}_{comp , up}}{{R}_{mix} \cdot {T}_{comp , up}}$$

Where p_{comp,} [symbol] is the compressor inlet pressure estimated in the low pressure EGR flow model 91, Rₘᵢₓ is the gas constant of the mixing between fresh air and low pressure EGR flow (287 J/KgK), T_{comp,} [symbol] is the compressor inlet temperature calculated from the enthalpy balance between the mixing of fresh air and low pressure EGR flow:

$${T}_{comp , up} = \frac{{c}_{P , air} \cdot {\dot{m}}_{air} \cdot {T}_{air} + {c}_{P , exk} \cdot {\dot{m}}_{DPF} \cdot {T}_{DPF}}{{c}_{P , air} \cdot {\dot{m}}_{air} + {c}_{P , exk} \cdot {\dot{m}}_{DPF}}$$

where [symbol] is the specific heat coefficient of the fresh air (1000 J/kgK), [symbol] is the specific heat coefficient of exhausts (1100 J/kgK), Tₐᵢᵣ is temperature of the fresh air measured by a sensor integrated in the MAF sensor, T_{LPE} is the temperature of the EGR measured by a dedicated sensor 84 placed downstream the low pressure EGR cooler, \dot{m}ₐᵢᵣ is the mass air flow measured by the MAF sensor, and \dot{m}_{LPE} is the low pressure EGR flow estimated in the low pressure EGR flow model 91.

The second part of embodiment of the invention requires the construction of a low pressure EGR control method. At least one goal of this function is to regulate the low pressure EGR valve to achieve the desired oxygen concentration within the low pressure EGR circuit portion that comprises the mixing point 22 and the intake manifold inlet 99.

The control structure can be divided into parts: first a standard PI (proportional and integral component) with a gain scheduling in function of the error amplitude and the engine operating point. Secondly a feed-forward component that is the core of the control structure as it allows optimal control performances especially in transient condition.

The low pressure EGR control feed-forward component uses a model-based approach; starting from the oxygen set-point, it is possible to calculate the associated EGR mass flow set-point and, thus, by reversing the equation used in the low pressure EGR flow model 91, it is possible to determine the desired low pressure EGR valve 62 position to achieve the desired charge air cooler oxygen set-point.

The calculation starts from the desired charge air cooler air fraction (f [symbol] _{,set-point}) or the desired upstream compressor air fraction calculated from the oxygen set-point; it is then possible to calculate the related mass air flow set-point as follows:

$${\dot{m}}_{air , set - point} = \frac{{\dot{m}}_{fuel} \cdot ( {f}_{ic , set - point} + {a}_{st} )}{1 + \frac{{\dot{m}}_{fuel}}{{\dot{m}}_{comp}} \cdot ( 1 + {a}_{st} ) - {f}_{ic , set - point}}$$

Where \dot{m}_{fuel} is the actual injected fuel mass flow, αₛₜ is the stoichmetric air to fuel ratio, and \dot{m}_{comp} is the compressor mass flow calculate in the low pressure EGR mixing model 92.

Once that the mass air flow set-point has been determined, it is possible to calculate the associated DPF outlet air fraction (f_{air,DPF,set-point}), the low pressure EGR rate (R_{LPE}) and the correspondent upstream compressor pressure:

$$\text{?} = \frac{\text{?}}{\text{?}} \\ \text{?} = \frac{\text{?} - 1}{\text{?}} \\ \text{?} = \text{?} - K \cdot \frac{\text{?}}{\text{?}} \text{?} \\ \text{?} \text{indicates text missing or illegible when filed} \qquad$$

Where \dot{m}_{fuel} is the actual injected fuel mass flow, αₛₜ is the stoichometric ratio, p_{amb} is the actual ambient pressure measured by a sensor integrated in the Engine Control Unit (ECU), and Tₐᵢᵣ is the actual temperature of the fresh air measured by a sensor integrated in the MAF sensor.

Once that R_{LPE} and \dot{m}_{air,set-point} are known, it is possible to calculate the low pressure EGR flow associated to the desired air fraction at the charge cooler outlet:

$$\text{?} = \frac{\text{?}}{1 - \text{?}}$$

$$\text{?} \text{indicates text missing or illegible when filed}$$

Finally, by using the same equation used in the low pressure EGR flow model 91 with input \dot{m}_{LPE,set-point}, p_{comp,} [symbol] _{,set-point}, p_{DPF,out,acutual} and T_{LPE,actual} it is possible to calculate the desired position of the low pressure EGR valve:

$$\text{?} = \frac{\text{?}}{\text{?}} \cdot {A}_{eff} \cdot f ( β )$$

$$\text{?} \text{indicates text missing or illegible when filed}$$

### With

$$β = \frac{\text{?}}{\text{?}}$$

$$\text{?} \text{indicates text missing or illegible when filed}$$

If the recirculated exhaust flow isn't in sonic condition (β≧β_{critic}) where:

$$β \text{?} = {( \frac{2}{k + 1} )}^{\frac{k}{k - 1}}$$

$$f ( β ) = \sqrt{( {β}^{\frac{2}{k}} - {β}^{\frac{k + 1}{k}} ) \cdot ( \frac{2 k}{k - 1} )} If β \leq {β}_{THR}$$

$$f ( β ) = \sqrt{( {β}^{\frac{2}{k}} - {β}^{\frac{k + 1}{k}} ) \cdot ( \frac{2 k}{k - 1} )} \cdot ( \frac{1 - β}{1 - {β}_{THR}} ) If β > {β}_{THR}$$

$$\text{?} \text{indicates text missing or illegible when filed}$$

If the recirculated exhaust flow is in sonic conditions (β<β_{critic}):

$$f ( β ) = \sqrt{k \cdot {( \frac{2}{k + 1} )}^{\frac{k + 1}{k - 1}}}$$

As previously stated, A_{eff} is a calibration parameter in function of the actual low pressure EGR valve position, and, thus, by calculating the value of A_{eff} that achieve the desired low pressure EGR flow (\dot{m}_{LPE,set-point}), it is possible to calculate the desired low pressure EGR valve 62 position by reversing the calibration parameter A_{eff}.

Numerous advantages correlate to the fact that the ECU is able to execute the steps of the model in real time and appropriately act upon valve 62. That means that the invention allows performance of an optimal control of Nitrogen Oxides (NOₓ) emissions of a diesel engine, by means of controlling the level of oxygen concentration in the intake manifold. This fact is particularly relevant in order to fulfil Euro VI regulations or higher.

Also in general, a Low Pressure EGR system can be used to achieve the requirements without using a specific after treatment system. The strategy of the invention allows therefore optimal control of the emission, especially in transient conditions.

Furthermore the alternative of measuring actual oxygen concentration within the low pressure EGR system by means of sensor would be suboptimal due to the physical location needed, due to unacceptable sensor lag and also due to cost of the sensor.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for controlling a level of oxygen concentration in an intake manifold of an internal combustion engine, said internal combustion engine comprising:
an intake line of the intake manifold comprising a leading point adapted to mix fresh air and a first EGR route and a second EGR route;
an exhaust manifold having and exhaust line
a charge air cooler located in the intake line upstream from the intake manifold and downstream the second EGR route;
a turbocharger comprising a compressor located in the intake line;
a turbine located in the exhaust line, the exhaust line comprising a diesel oxidation catalyst (DOC) and an antiparticulate filter (DPF);
a regulator adapted to regulate a flow rate of an exhaust gas, said regulator comprising a low pressure EGR valve associated with said second EGR route,
the method comprising:
determining an oxygen concentration set-point at any point in a portion of the intake line comprised between said leading point up to said intake manifold; and
maintaining a desired oxygen concentration set-point in the any point of said portion.

2. The method as in claim 1, wherein the determining the oxygen concentration set-point comprises:
determining a delay of an exhaust mass air fraction in a passage between the exhaust manifold and the DPF outlet;
calculating a time constant representative of the delay,
wherein the time constant is a function of an engine operating point τ=f(engine speed, injected fuel).

3. The method as in claim 1, wherein the determining the oxygen concentration set-point comprises:
determining a delay of an exhaust mass air fraction in a passage between the exhaust manifold and the DPF outlet;
calculating a time constant representative of the delay,
wherein the time constant is determined considering A volume of the exhaust line and an exhaust mass flow passing through the volume.

4. The method as in claim 1, wherein the determining the oxygen concentration set-point comprises determining of an EGR flow exiting from a low pressure loop of said second EGR route.

5. The method as in claim 2, wherein the determining the oxygen concentration set-point comprises:
calculating a recirculated EGR flow taking into account a sonic condition; and
determining A total compressor flow as a sum of fresh air and an EGR flow recirculated from a low pressure loop of said second EGR route.

6. The method as in claim 5, wherein the determining the oxygen concentration set-point comprises:
determining the delay of an upstream compressor mass air fraction; and
calculating the time constant representative of the delay,
wherein the time constant is determined either as the function of the engine operating point τ=f(engine speed, infected fuel).

7. The method as in claim 5, wherein the determining the oxygen concentration set-point comprises:
determining the delay of an upstream compressor mass air fraction; and
calculating the time constant representative of the delay,
wherein the time constant is determined considering a volume of the intake line, composed by the charge air cooler and intake pipe, and a mass flow passing through the volume.

8. The method as in claim 5, wherein the determining the oxygen concentration set-point comprises:
determining the delay of a compressor flow between the compressor inlet and the charge air cooler outlet; and
calculating the time constant representative of the delay,
wherein the time constant is determined either as the function of the engine operating point ρ=f(engine speed, infected fuel).

9. The method as in claim 5, wherein the determining the oxygen concentration set-point comprises:
determining the delay of a compressor flow between the compressor inlet and the charge air cooler outlet; and
calculating the time constant representative of the delay,
wherein the time constant is determined with consideration given to a volume of the intake line and a volumetric flow passing through the volume.

10. The method as in claim 1, wherein the maintaining the desired oxygen concentration set-point in the any point of said portion comprises:
regulating of the low pressure EGR valve,
using a feed-forward loop starting from an oxygen set-point in order to calculate an associated EGR mass flow set-point;
reversing a relationship used in a low pressure EGR flow determination phase; and
determining the low pressure EGR valve position to achieve a desired oxygen set-point.

11. The method as in claim 10, wherein the regulating of the low pressure EGR valve comprises calculating that starts from a desired charge air cooler air fraction (f [symbol] _{,set-point}) calculated from the oxygen set-point, in order to calculate a related mass air flow set-point.

12. The method as in claim 10, further comprising determining a basis of a mass air flaw set-point, an associated DPF outlet air fraction (f_{air,DPF,set-point}), a low pressure EGR rate (R_{LPE}) and a correspondent upstream compressor pressure.

13. The method as in claim 5, further comprising calculating a desired position of the low pressure EGR valve is a second function of a desired air fraction at the charge air cooler outlet according to:
$$\text{?} = \frac{\text{?}}{\text{?}} \cdot {A}_{eff} \cdot f ( β )$$
$$\text{?} \text{indicates text missing or illegible when filed}$$
With:
$$β = \frac{\text{?}}{\text{?}}$$
$$\text{?} \text{indicates text missing or illegible when filed}$$
on condition that, if the recirculated EGR flow is not in the sonic condition (β≧β_{critic}) where:
$$β \text{?} = {( \frac{2}{k + 1} )}^{\frac{k}{k - 1}}$$
$$f ( β ) = \sqrt{( {β}^{\frac{2}{k}} - {β}^{\frac{k + 1}{k}} ) \cdot ( \frac{2 k}{k - 1} )} If β \leq {β}_{THR}$$
$$f ( β ) = \sqrt{( {β}^{\frac{2}{k}} - {β}^{\frac{k + 1}{k}} ) \cdot ( \frac{2 k}{k - 1} )} \cdot ( \frac{1 - β}{1 - {β}_{THR}} ) If β > {β}_{THR}$$
$$\text{?} \text{indicates text missing or illegible when filed}$$
or, if the recirculated EGR flow is in sonic conditions (β<β_{critic}):
$$f ( β ) = \sqrt{k \cdot {( \frac{2}{k + 1} )}^{\frac{k + 1}{k - 1}}} .$$

14. An internal combustion engine, comprising:
an intake manifold;
an intake line of the intake manifold comprising a leading point adapted to mix fresh air and a first EGR route and a second EGR route;
an exhaust manifold having and exhaust line
a charge air cooler located in the intake line upstream from the intake manifold and downstream the second EGR route;
a turbocharger comprising a compressor located in the intake line;
a turbine located in the exhaust line, the exhaust line comprising a diesel oxidation catalyst (DOC) and an antiparticulate filter (DPF);
a regulator adapted to regulate a flow rate of an exhaust gas, said regulator comprising a low pressure EGR valve associated with said second EGR route; and
a control unit configured to:
determine an oxygen concentration set-point at any point in a portion of the intake line comprised between said leading point up to said intake manifold; and
maintain a desired oxygen concentration set-point in the any point of said portion.

15. The internal combustion engine of claim 14, wherein the internal combustion engine is a Diesel engine.

16. The internal combustion engine as in claim 14, wherein the control unit is configured to:
determine a delay of an exhaust mass air fraction in a passage between the exhaust manifold and the DPF outlet;
calculate a time constant representative of the delay,
wherein the time constant is a function of an engine operating point ρ=f(engine speed, infected fuel).

17. The internal combustion engine as in claim 14, wherein the control unit is configured to:
determine a delay of an exhaust mass air fraction in a passage between the exhaust manifold and the DPF outlet;
calculate a time constant representative of the delay,
wherein the time constant is determined considering a volume of the exhaust line and an exhaust mass flow passing through the volume.

18. The internal combustion engine as in claim 14, wherein the control unit is configured to determine an EGR flow exiting from a low pressure loop of said second EGR route.

19. The internal combustion engine as in claim 15, wherein the control unit is configured to:
calculate a recirculated EGR flow taking into account a sonic condition; and
determine a total compressor flow as a sum of fresh air and EGR flow recirculated from a low pressure loop of said second EGR route.

20. The internal combustion engine as in claim 19, wherein the control unit is configured to:
determine a delay of an upstream compressor mass air fraction; and
calculate a time constant representative of the delay,
wherein the time constant is determined either as a function of an engine operating point ρ=f(engine speed, infected fuel).

21. The internal combustion engine as in claim 19, wherein the control unit is configured to:
determine the delay of an upstream compressor mass air fraction; and
calculate a time constant representative of the delay,
wherein the time constant is determined considering a volume of the intake line, composed by the charge air cooler and intake pipe, and a mass flow passing through the volume.

22. The internal combustion engine as in claim 20, wherein the control unit is configured to:
determine the delay of a compressor flow between the compressor inlet and the charge air cooler outlet; and
calculate the time constant representative of the delay,
wherein the time constant is determined either as the function of the engine operating point ρ=f(engine speed, infected fuel).

23. The internal combustion engine as in claim 20, wherein the control unit is configured to:
determine the delay of a compressor flow between the compressor inlet and the charge air cooler outlet; and
calculate the time constant representative of the delay,
wherein the time constant is determined with consideration given to a volume of the intake line and a volumetric flow passing through the volume.

24. The internal combustion engine as in claim 14, wherein the control unit is configured to:
regulate the low pressure EGR valve using a feed-forward loop starting from an oxygen set-point in order to calculate an associated EGR mass flow set-point;
reverse a relationship used in a low pressure EGR flow determination phase; and
determine a desired low pressure EGR valve position to achieve the oxygen set-point.

25. The internal combustion engine as in claim 24, wherein the control unit is configured to start calculating from a desired charge air cooler air fraction (f [symbol] _{,set-point}) calculated from the oxygen set-point, in order to calculate a related mass air flow set-point.

26. The internal combustion engine as in claim 24, wherein the control unit is configured to determine a basis of a mass air flow set-point, an associated DPF outlet air fraction (f_{air,DPF,set-point}), a low pressure EGR rate (R_{LPE}) and a correspondent upstream compressor pressure.

27. The internal combustion engine as in claim 19, wherein the control unit is configured to calculate a desired position of the low pressure EGR valve in function of a desired air fraction at the charge air cooler outlet according to:
$$\text{?} = \frac{\text{?}}{\text{?}} \cdot {A}_{eff} \cdot f ( β )$$
$$\text{?} \text{indicates text missing or illegible when filed}$$
With:
$$β = \frac{\text{?}}{\text{?}}$$
$$\text{?} \text{indicates text missing or illegible when filed}$$
on condition that, if the recirculated EGR flow is not in the sonic condition (β≧β_{critic}) where:
$$β \text{?} = {( \frac{2}{k + 1} )}^{\frac{k}{k - 1}}$$
$$f ( β ) = \sqrt{( {β}^{\frac{2}{k}} - {β}^{\frac{k + 1}{k}} ) \cdot ( \frac{2 k}{k - 1} )} If β \leq {β}_{THR}$$
$$f ( β ) = \sqrt{( {β}^{\frac{2}{k}} - {β}^{\frac{k + 1}{k}} ) \cdot ( \frac{2 k}{k - 1} )} \cdot ( \frac{1 - β}{1 - {β}_{THR}} ) If β > {β}_{THR}$$
$$\text{?} \text{indicates text missing or illegible when filed}$$
or, if the recirculated EGR flow is in sonic conditions (β<β_{critic}):
$$f ( β ) = \sqrt{k \cdot {( \frac{2}{k + 1} )}^{\frac{k + 1}{k - 1}}} .$$
